(19) United States
(12) Patent Application Publication
(10) Pub. No.: US 2025/0111704 A1
(43) Pub. Date: Apr. 3, 2025

(54) MAINTAINING VEHICLE ANONYMITY DURING CLOUD-SUPPORTED VEHICLE LOCALIZATION AND CONTROL

(71) Applicant: ClearMotion, Inc., Billerica, MA (US)

(72) Inventors: Jack A. Ekchian, Belmont, MA (US); John Parker Eisenmann, Burlington, MA (US)

(73) Assignee: ClearMotion, Inc., Billerica, MA (US)

(21) Appl. No.: 18/729,574

(22) PCT Filed: Jan. 17, 2023
(86) PCT No.: PCT/US2023/010896

§ 371 Date: Jul. 17, 2024

Related U.S. Application Data
(60) Provisional application No. 63/300,424, filed on Jan. 18, 2022.

(51) Int. Cl. G07C 5/00; B60G 17/016; G07C 5/02; H04W 4/021

(52) U.S. Cl. CPC G07C 5/008; B60G 17/016; G07C 5/02; H04W 4/021

(57) ABSTRACT

Methods related to the exchange of vehicle related information between a vehicle and a remote database are disclosed. In some implementations, data may be collected based on measurements with a sensor onboard a vehicle. A location of the vehicle may also be determined. If the location is within a data protection zone or in a data protection road segment, the exchange of the vehicle related information may be avoided or curtailed to protect the anonymity of the vehicle and/or its occupants. If the vehicle is outside of the data protection zone or road segment, vehicle data may be exchanged with the remote database. In some implementations, the data protection zone or road segment may be determined based on information received from a user interface in the vehicle.

### CROSS-REFERENCE TO RELATED APPLICATIONS

This application claims the benefit under 35 U.S.C. § 119 of U.S. Provisional Application Ser. No. 63/300,424, filed Jan. 18, 2022, the entire contents of which is incorporated herein by reference.

### FIELD

Disclosed embodiments are related to systems for anonymizing vehicle used in connection with terrain-based localization and insights for systems in vehicles and related methods of use.

### BACKGROUND

Road surface data from a remote centralized database may be used for highly accurate localization and control of various vehicle systems, such as, advanced driver assistance systems (ADAS), active suspension systems, semi-active suspension systems, and/or autonomous or semi-autonomous driving controllers.

### SUMMARY

According to aspects of the disclosure, there is provided a method of operating a vehicle, on a road surface, while exchanging vehicle specific information with a remote database. The method may include: collecting data based on measurements with a sensor onboard the vehicle traveling on a road surface; determining a location of the vehicle when the data is being collected; determining whether the location is within a predetermined data protection zone; and uploading the collected data to a remote database, if the location is not in the data protection zone. In some embodiments, the method may include storing the collected data in a local database onboard the vehicle if the location is in the data protection zone. In some embodiments, the collected data includes information related to the road surface. In some embodiments, the collected data may include information that may be used to determine the location of the vehicle, by for example using terrain-based localization based on localization. In some embodiments, the method may include using geofencing to specify the data protection zone. In some embodiments, the data protection zone may be established based on parameters received via a user interface (UI) or Human Machine Interface (HMI). In some embodiments, the determining the location of the vehicle inside the data protection zone may be at least partially based on information received from GNSS receiver onboard the vehicle. In some embodiments, the determining the location of the vehicle outside the data protection zone may be at least partially based on information about the road received from the remote databased. In some embodiments, where the remote database is in the cloud. In some embodiments, further comprising controlling at least one system onboard the vehicle based on information about the road received from the remote database when the vehicle is outside the data protection zone. In some embodiments, the at least one system is a suspension system.

According to aspects of the disclosure, there is provided a method for limiting exchange of information between a vehicle traveling on a road surface and a remote database. The method may include: receiving information from a user interface; establishing a first data protection zone associated with the vehicle; and limiting the exchange of information, with the remote database, related to a position of the vehicle and/or to data collected by the vehicle in the first data protection zone. In some embodiments, the user interface may be on board the vehicle. In some embodiments, user interface is a cellphone application. In some embodiments, is a computer application. In some embodiments, the information from the user interface includes a geocoordinate of a position in the first data protection zone or on the boundary of the data protection zone. In some embodiments, the first data protection zone is a circle, wherein the position is the center of the circle, and wherein the information from the user interface also includes a radius of the circle. In some embodiments, the method may also include receiving additional information from the user interface, establishing a second data protection zone associated with the vehicle; and limiting the exchange of information, with the remote database, related to a position of the vehicle and/or data collected by the vehicle in the second data protection zone. In some embodiments, the limiting of the exchange of information includes preventing uploading of road vehicle position and/or surface information collected by the vehicle in a data protection zone.

According to aspects of the disclosure, there is provided a method for limiting exchange of road surface information between a vehicle, traveling along a route of travel, and a remote database. The method may include: collecting road surface information while traveling along the travel route with the vehicle, based on data from at least one sensor onboard the vehicle; and limiting an upload of at least a portion of road surface information collected while traveling along a predetermined first portion of the travel route. In some embodiments, the first portion of the travel route is a portion at a beginning of the route. In some embodiments, the first portion of the travel route is a portion at an end of the route. In some embodiments, the method may include receiving information about the route of travel from a navigation system associated with the vehicle, and determining the portion at least partially based on the information received from the navigation system. In some embodiments, the method may include storing at least a portion of road surface information collected while traveling along the predetermined first portion of the travel route in a local database onboard the vehicle. In some embodiments, the method may include operating at least one system onboard the vehicle based on the road surface information stored in the local database, during subsequent travel by the vehicle along the predetermined portion. In some embodiments, the at least one system is a suspension system. In some embodiments, the suspension system is an active suspension system.

According to aspects of the disclosure, there is provided a method for operating a vehicle, on a road surface, while exchanging vehicle specific information with a remote database. The method may include: using GNSS to determine an approximate location of the vehicle; determining whether the approximate location is in a predetermined data protection zone or on a data protection road segment; providing the approximate location of the vehicle to the remote database if the vehicle is not in the predetermined data protection zone or on a data protection road segment.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various nonlimiting embodiments when considered in conjunction with the accompanying figures.

### BRIEF DESCRIPTION OF DRAWINGS

FIG. 1 illustrates a cloud-based vehicle localization and control system that includes two independent cloud-based databases.

FIG. 2 illustrates a road network where two data protection zones are shown.

FIG. 3 illustrates the road segment where two data protection road segments are shown.

FIG. 4 illustrates a method for operating a vehicle during periods when data exchange with a remote data base is restricted in order to protect the anonymity of the vehicle.

### DETAILED DESCRIPTION

A vehicle traveling along a road, autonomously or under the control of a driver, may interact with one or more road surface features that may expose the vehicle and/or one or more vehicle occupants to certain forces or accelerations. Such road features may affect the comfort and/or safety of vehicle occupants as well as wear-and-tear of the vehicle. The magnitude, direction, and/or frequency content of such forces or accelerations may be a function of the characteristics of one or more aspects or features of the road surface. A typical road may include various types of road surface features, such as for example, road surface anomalies including, but not limited to potholes, frost heaves or other bumps, surface cracks, expansion joints, rough patches, rumble strips, storm grates, etc.; and/or road surface properties, including but not limited to road surface texture, road surface composition, surface camber, surface slope, etc. Road surface properties may affect road surface parameters, such for example, the friction coefficient between the tires of a vehicle and the road, traction and/or road-grip.

Properties and road surface features, of a road a vehicle may be traveling over, may be mapped to provide forward-looking information about the road surface features located along a path of travel of a vehicle. This information about the road surface features ahead of the vehicle may be used to, for example, dynamically tune, prepare, and/or control various automated or partially automated systems in the vehicle (such as for example, suspension systems (e.g., semi or fully active), propulsion systems, adaptive driver assistance systems (ADAS), electric power steering systems (EPS), antilock braking systems (ABS), etc.).

Localization systems and methods incorporating terrain-based localization may offer better resolution than a system localizing based purely on a Global Navigation Satellite System (GNSS). In a terrain-based localization system, as a vehicle travels along a road, a previously measured road profile may be obtained by measuring vertical motion of a portion of the vehicle using one or more motion sensors attached to the vehicle. This measured road surface information (e.g. road profile) may be compared with a reference road surface information obtained from a remote or local database, and based at least in part on this comparison, the position of the vehicle along the road may be determined. The reference road surface information may be based on information gathered during multiple trips along the same road by one or more vehicles. Road surface information may be stored in a remote database, e.g., in the cloud, and accessed at a microprocessor onboard a vehicle when needed and used to localize the vehicle as well as to control one or more vehicle systems.

In some embodiments, a vehicle traveling along a road, may request accesses to information about the road surface that is stored in a cloud database to be used for terrain-based localization or preview control of onboard systems. The requesting vehicle may also provide (e.g. upload) certain information to the cloud database. This uploaded information may include, but is not limited to, the vehicle's estimated current location (e.g., based on geocoordinates obtained from an onboard GNSS receiver), road surface information about the road collected by the vehicle while traveling along the road, and/or information that may uniquely identify the vehicle. Such uniquely identifiable vehicle information may include, e.g., the vehicle's Vehicle Identification Number (VIN), a cell phone number associated with the vehicle, or an IP address of communication equipment on-board the vehicle accessing the internet. The uploaded road-surface information may be used to update or otherwise enhance the data about the road in the cloud database. The uniquely identifiable information about the vehicle may be used to track information received from a particular vehicle for various reasons, such as for example, quality control or data interpretation. For example, in some cases, a vehicle may have sensors that are malfunctioning and may occasionally or continually produce faulty data. To avoid incorporating information from a vehicle that has previously provided faulty information, vehicles may be rated according to the reliability of the data that they produce. Such a rating score may be associated with the vehicle ID so that poor quality data may be eliminated or deemphasized. Additionally or alternatively, the vehicle ID may be used to determine the model of the vehicle so that its performance or response may be compared to the performance of other vehicles of the same or similar models with similar mileage. Based on this comparison, the off-design performance of one or more vehicle systems may be identified and report back to the vehicle. Additionally or alternatively, data reported by a particular vehicle while traveling over the same or similar roads may be associated with the vehicles unique identifier so that any unusual or unexpected degradation may be detected and reported to the vehicle. Accordingly, providing uniquely identifiable information about the vehicle may enable certain valuable vehicle specific information to be returned to the vehicle in addition to the road surface information for the current location of the vehicle.

When serving road data to a vehicle for consumption, the cloud can save bandwidth by only serving the most likely paths which the vehicle will traverse. While some roads are generally more popular and likely to be traversed, individual driver behaviors may prefer certain roads. For example, a driver may often traverse a particular back road to reach their home residence. If the cloud application knows that the vehicle often traverses this back road, it can conserve cellular bandwidth by only serving road data along that road (and not surrounding roads). Therefore it is of interest for the cloud application to keep track of individual driver behaviors, and the cloud requires information which uniquely identifies each vehicle to do so.

In some embodiments of cloud-based vehicle localization and/or control systems, there may be a multiplicity of independent cloud-based databases that may be used. As used herein, the term “independent cloud-based databases” refers to two or more cloud-based databases that are owned or operated by entities, e.g., corporations, that may be managed independently of each other.

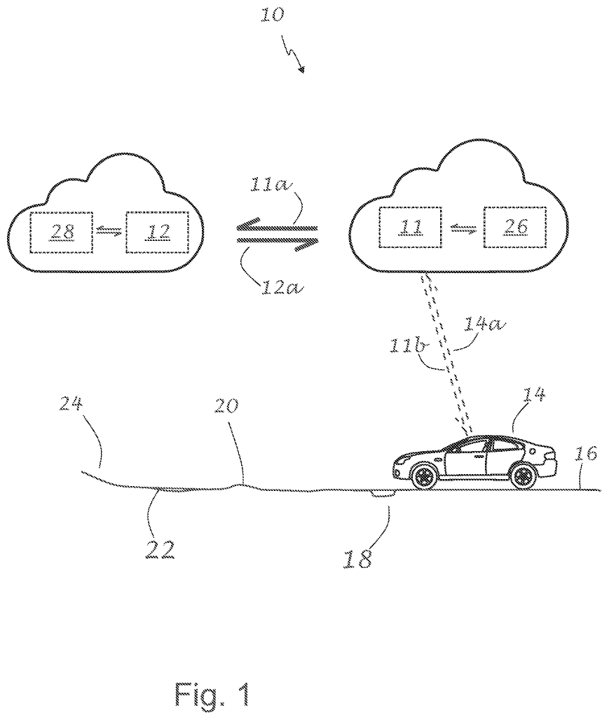

FIG. 1 illustrates a cloud-based vehicle localization and control system 10 that may include two independent databases or data repositories, e.g., cloud-based databases 11 and 12. Cloud-based database 11, may, for example, be owned, controlled (directly or indirectly), or managed (directly or indirectly) by a vehicle manufacturer. Cloud-based database 12, may, for example, be owned, controlled (directly or indirectly), or managed (directly or indirectly) by an entity that is independent from the entity that owns, controls, or manages database 11. Database 11 may communicate directly with vehicle 14 to receive information from vehicle 14 including, for example, data about the estimated location of the vehicle (which may be determined by using GNSS), and/or information about a portion the road surface just traversed. Additionally or alternatively database 11 may supply information to the vehicle, e.g., information about the road to be traversed by the vehicle. Exchanged road related data may include information about the road surface profile (e.g., anomalies, discontinuities of the road surface) and/or road surface properties, e.g., surface coefficient of friction, at various points or portions along road surface 16. For example, road surface information may include data about the characteristics (e.g., width, height, depth, length) of anomalies that may be on the same scale as the vehicle (e.g., pothole 18, bump (e.g., frost heave) 20, and depression 22 or aspects of the road surface that may characterize a portion of the road that is larger than the vehicle, such as a change in the nominal road slope 24. The data uploaded by vehicle 14 to cloud-based database 11 may also include unencrypted or publicly recognizable vehicle-identifying metadata (i.e., “public vehicle identifiers”) such as, for example, Vehicle Identification Number (VIN), a cell phone number associated with vehicle 14, or an IP address of communication equipment on-board vehicle 14 that is used to access the internet.

At least a portion of the information 14a associated with vehicle 14 reaching database 11 may be transferred to independent database 12 for further analysis and/or processing. However, before forwarding such data to database 12, a microprocessor 26, associated with database 11, may alter or replace at least a portion of the public vehicle identifiers, that may identify the source vehicle 14 of the data 14a. In some implementations, the processor 26 may generate new or modified confidential or encrypted unique tracking identifiers (i.e., “private vehicle identifiers”) that are associated with the portion of the data 14a that is supplied to database 12. The private tracking identifiers may be used by one or more microprocessors 28, associated with database 12, to track data 14a without having access to some or all of the original public vehicle identifiers transmitted to database 11 by vehicle 14.

In some embodiments, a unique private tracking identifier may be assigned to each vehicle providing data that reaches database 12, or to each interval of drive session data from a given vehicle that reaches database 12. In some embodiments, a per-session identification scheme may be used to track data associated with a vehicle in database 12 without access to public vehicle identifiers. Under the circumstance that each session is assigned a unique tracking identifier, database 11 may maintain a map relating public and private vehicle identifiers. By using such a map, in some embodiments, processor 26 may recover the vehicle identity of any session referenced by processor 28.

The microprocessor 28 may append or otherwise associate appropriate tracking private vehicle identifiers to data 12a that is transmitted back to database 11. Microprocessor 26 may then rely on the private tracking identifier to identify vehicle 14 and transmit, to vehicle 14, information 11b that may, for example, be related to the location of vehicle 14 and/or the operation of one or more systems in that vehicle. Such information may include information about the capacity of one or more systems onboard the vehicle to perform certain tasks, e.g., sensors to collect certain data and a suspension system to apply certain passive or active forces.

Consequently, data may be exchanged between a remote database and a vehicle, e.g., database 12 and vehicle 14 respectively, and/or processed by a processor associated with the remote database, e.g., microprocessor 28, while limiting access to public vehicle identifiers associated with the vehicle, e.g. vehicle 14, by the independent remote database, e.g. cloud-based data base 12.

Inventors have recognized that, in some embodiments, under certain operating conditions, because vehicles may frequently travel the same route, e.g., on a daily basis, each work day from home to work and back, it may be possible to identify a particular vehicle with specificity based on information about, e.g., the start and the end of a vehicle's daily trips.

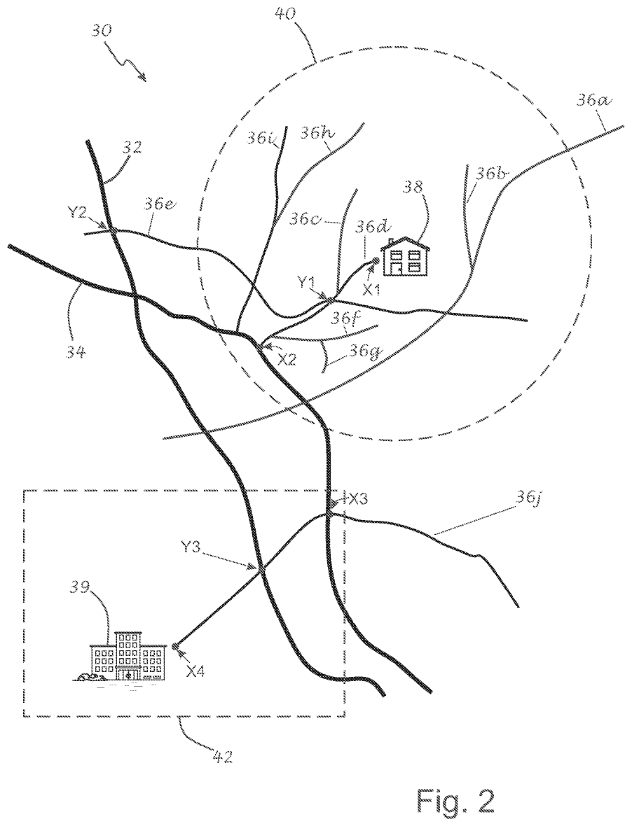

FIG. 2 illustrates an exemplary road network with primary roads 32 and 34, and secondary roads 36a-36j. A person living in home 38 and working in building 39 may, for example, travel along secondary road 36d from point X1 to point X2, along primary road 34 from point X2 to point X3, and along secondary road 36j from point X3 to reach a destination at point X4. Alternatively, the person living in home 38 may elect to drive or be driven, e.g., by an autonomous vehicle, to work by, for example, traveling along secondary road 36d from point X1 to point Y1, along secondary road 36e from point Y1 to point Y2, along primary road 32 from point Y2 to point Y3, and along secondary road 36j from point Y3 to the destination at point X4. During the return trip the person may travel along one of these two routes in the reverse direction or select a partially or totally different route.

A vehicle, travelling along these routes, may identify its location to a remote database (e.g., a cloud-based database) and request road surface information that may be used, for example, for terrain-based localization (which may be more accurate and/or precise than GNSS localization) and control of one or more onboard systems. The vehicle may also upload information collected by it to the remote database, where the information may be used to update or add to information, stored in the remote database, about the road surface being travelled.

In some embodiments, under certain operating conditions, a vehicle manufacturer, owner, operator and/or occupant may wish to upload information to the remote database and/or download road surface information that it may be able to use. However, such organizations and/or individuals may not wish the vehicle to be identified with a high degree of specificity such that from then on, its location may be tracked based on its interactions with the cloud. The anonymity of a vehicle may be protected by establishing one or more data protection zones. Two such zones, a circular zone 40 with its center located at house 38 and a rectangular zone 42 that includes building 39, are illustrated FIG. 2. A system onboard the vehicle, or in the cloud, may prevent or limit the exchange of certain information or types of information, that may be used to identify the vehicle with specificity, from being exchanged by the vehicle when it is in any data protection zone. The size, shake, and/or location of the zones may be determined by systems on-board the vehicle, in the cloud, and/or based on information provided by a vehicle operator, owner, and or manufacturer. The size, shake, and/or location of the zones may be determined based on information, e.g. about the type or model of a vehicle, the population density of vehicles of a particular type or model in a particular area, and/or the population density of vehicles in general in a particular area.

The vehicle may continue to collect road surface information when it is in a data protection zone but instead of uploading the data to the remote data base, the vehicle may retain the data locally and develop a self-contained road surface information database that it may use, during subsequent trips, for terrain-based localization and/or control of one or more systems onboard the vehicle. Alternatively, a vehicle operator traveling from within data protection zone 40 may download information for some or all roads in the zone off-line, without identifying the specific location of the vehicle. This data may then be stored locally and accessed for the purposes of terrain-based localization and/or onboard system control.

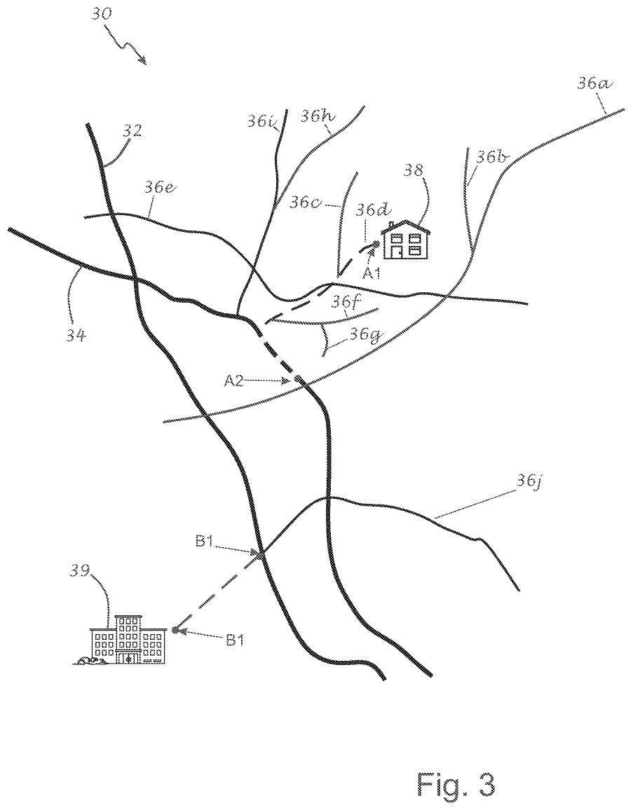

FIG. 3 illustrates the road network 30 of FIG. 2, where a system onboard the vehicle, or in the cloud, may prevent or limit data exchange with the remote database during an initial and/or final portions of a trip. For example, a vehicle traveling from home 38 to building 39 may avoid uploading vehicle position information and/or road surface information collected by the vehicle during the initial portion of the trip, e.g., from point A1 to point A2 and the final portion of the trip from point B1 and point B2. The length of these portions in time of travel or distance may be preselected and varied based on, e.g., population density of vehicles or people in a particular area. In areas where there is high population density the length of the initial and/or final portions of the trip may be shorter. In areas that are sparsely populated, the initial and/or final portions of the trip may be longer so as to safeguard anonymity.

In some implementations, the size, shape, and/or location of a data protection zone, or the length of the initial or end portions of a road that are data protection road segments, may be defined by using an in-vehicle Human Machine Interface (HMI) system. Alternatively, in some implementations, a constant distance interval of data at the beginning and/or end of each session may be automatically excluded from uploads. For example, excluding data collected during the first and last mile of, for example, a 10 mile drive session may sufficiently obfuscate the origin and destination of a vehicle's trip. In order to achieve this, the vehicle may selectively upload data with some time delay. When the vehicle finishes a drive session, it may discard pending upload data in order to conceal its destination and/or protect the anonymity of the vehicle owner, operator, and/or occupant. Alternatively or additionally, the initial and/or final segments of a road may be determined based on information about a planned route from a navigation system.

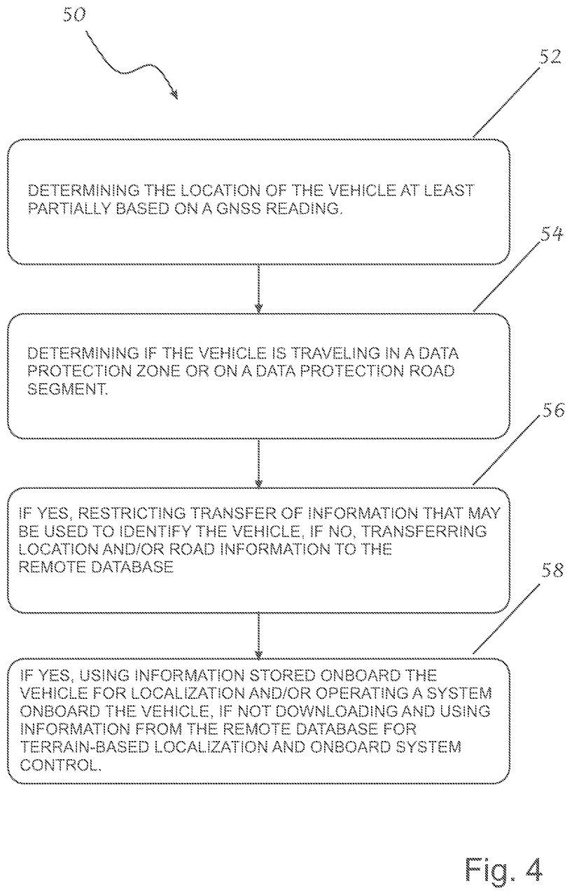

Referring to FIG. 4, a method 50 is illustrated for operating a vehicle during periods when data upload to a remote database is restricted in order to protect the anonymity of the vehicle. The method includes determining the location of the vehicle using GNSS (52), determining if the vehicle is traveling in a data protected zone or on a data protected road segment (54), if yes, restricting the uploading of certain information to the remote database, if no, exchanging location and/or road information with the remote database (56), if yes, using information stored onboard the vehicle for terrain-based localization and/or controlling a system onboard the vehicle, if no, using the information from the remote database for terrain-based localization and/or controlling a system onboard the vehicle (58).

Alternatively, in certain implementations (e.g. such as described in connection with FIGS. 1-4) road related information collected by a vehicle may be provided to multiple cloud-based databases. For example, sensitive information, e.g. that may be used for vehicle identification, such as data collected in the data protection zones (e.g. as described in connection with FIG. 2) or data protection road segments (e.g. as described in connection with FIG. 3), may be exclusively shared with certain databases (such as a database owned or controlled by the vehicle's OEM), while less sensitive information, e.g. that cannot readily be used for vehicle identification, may be shared more broadly, with other databases.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A method of operating a vehicle, on a road surface, while exchanging vehicle specific information with a remote database, the method comprising:
collecting data based on measurements with a sensor onboard the vehicle traveling on a road surface;
determining a location of the vehicle when the data is being collected;
determining whether the location is within a predetermined data protection zone; and
uploading the collected data to a remote database if the location is not in the data protection zone.

2. The method of claim 1, further comprising storing the collected data in a local database onboard the vehicle if the location is in the data protection zone.

3. The method of claim 1, wherein the collected data includes information related to the road surface.

4. The method of claim 1, wherein the collected data includes information that may be used to determine the location of the vehicle.

5. The method of claim 1, further comprising using geofencing to specify the data protection zone.

6. The method of claim 1, wherein the data protection zone is established based on parameters received via a user interface.

7. The method of claim 1, wherein determining the location of the vehicle inside the data protection zone is at least partially based on information received from GNSS receiver onboard the vehicle.

8. The method of claim 1, wherein determining the location of the vehicle outside the data protection zone is at least partially based on information about the road received from the remote databased.

9. The method of claim 1, wherein the remote database is in the cloud.

10. The method of claim 1, further comprising controlling at least one system onboard the vehicle based on information about the road received from the remote database when the vehicle is outside the data protection zone.

11. The method of claim 10, wherein the at least one system is a suspension system.

12. The method of claim 11, wherein the at least one system is an active suspension system.

13. A method of limiting exchange of information between a vehicle traveling on a road surface and a remote database, the method comprising:
receiving information from a user interface;
establishing a first data protection zone associated with the vehicle; and
limiting the exchange of information, with the remote database, related to a position of the vehicle and/or to data collected by the vehicle in the first data protection zone.

14. The method of claim 13, wherein the user interface is on board the vehicle.

15. The method of claim 14, wherein the user interface is a cellphone application.

16. The method of claim 14, wherein the user interface is a computer application.

17. The method of claim 13, wherein the information from the user interface includes a geocoordinate of a position in the first data protection zone or on a boundary of the data protection zone.

18. The method of claim 17, wherein the first data protection zone is a circle, wherein the position is a center of the circle, and wherein the information from the user interface also includes a radius of the circle.

19. The method of claim 13, further comprising:
receiving additional information from the user interface,
establishing a second data protection zone associated with the vehicle; and
limiting the exchange of information, with the remote database, related to a position of the vehicle and/or data collected by the vehicle in the second data protection zone.

20. The method of claim 13, wherein the limiting of the exchange of information includes preventing uploading of road vehicle position and/or surface information collected by the vehicle in a data protection zone.

21. A method of limiting exchange of road surface information between a vehicle, traveling along a route of travel, and a remote database, the method comprising:
based on data from at least one sensor onboard the vehicle, collecting road surface information while traveling along the travel route with the vehicle; and
limiting an upload of at least a portion of road surface information collected while traveling along a predetermined first portion of the travel route.

22. The method of claim 21, wherein the first portion of the travel route is a portion at a beginning of the route.

23. The method of claim 21, wherein the first portion of the travel route is a portion at an end of the route.

24. The method of claim 21, further comprising:
receiving information about the route of travel from a navigation system associated with the vehicle, and
determining the portion at least partially based on the information received from the navigation system.

25. The method of claim 21, further comprising storing at least a portion of road surface information collected while traveling along the predetermined first portion of the travel route in a local database onboard the vehicle.

26. The method of claim 25, further comprising, during subsequent travel by the vehicle along the predetermined portion, operating at least one system onboard the vehicle based on the road surface information stored in the local database.

27. The method of claim 26, wherein the at least one system is a suspension system.

28. The method of claim 27, wherein the suspension system is an active suspension system.

29. A method of operating a vehicle, on a road surface, while exchanging vehicle specific information with a remote database, the method comprising:
using GNSS to determine an approximate location of the vehicle;
determining whether the approximate location is in a predetermined data protection zone or on a data protection road segment; and
providing the approximate location of the vehicle to the remote database if the vehicle is not in the predetermined data protection zone or on a data protection road segment.
